(19) United States
(12) Patent Application Publication
(10) Pub. No.: US 2006/0235756 A1
(43) Pub. Date: Oct. 19, 2006

(54) Virtual "web radio" that allows for the free on-demand streaming of individual files of songs, films, and other media in digital format that would otherwise need to be purchaed, which depends upon revenue earned from advertisers who pay to have their advertisements appended to the front of files streams available on the virtual 'web radio"

(76) Inventor: Thomas Patrick Pellegrino, New Market, MD (US)

Correspondence Address: THOMAS P. PELLEGRINO, 2351 38TH STREET, APT. # B-3, ASTORIA, NY, 11105, US

(21) Appl. No.: 10/866,278

(22) Filed: Jun. 14, 2004

(51) Int. Cl. G06Q 30/00; G07F 19/00; G06F 15/16

(52) U.S. Cl. 705/26; 709/231; 705/30

(57) ABSTRACT

This online file streaming and advertising business method allows for the creation of an internet community based around a virtual “web radio” wherein any song, movie, TV show, fashion video or sound clip, etc. can be made individually available for free. Any and all media companies may provide exclusive media content for the virtual “web radio” and its associated web site. When a file is streamed to an individual's computer, the file cannot be saved to the computer or copied by the individual in any way. The files are available for free to the individual on the virtual “web radio” because they are pre-paid for by advertisers who pay to have their advertisement put at the beginning of the file being streamed. Similar to television and radio, this business method improvement comprises offering content to the public for free as a platform for advertising. Yet this business method is unlike radio or TV however, because the individual is literally forced to view or hear the advertisement: they have the ability to pause the transfer, but cannot fast-forward or skip past the advertisement. This method of appending advertisements to the beginning of digital streams constitutes an improvement on existing business methods for combining advertising with such content as television programs, web pages, films, or radio. This business method is an improvement on the effectiveness of advertising.

### BACKGROUND OF THE INVENTION

1. Field of the Invention

This invention relates to online media file sharing and advertising, in particular, media file streaming with advertisements appended to the front of each individual file being streamed.

2. Description of Related Art including information disclosed under 37 CFR 1.97 and 1.98

It is known that there is no presently successful business method for combining advertisements and individual file streams into an industry large enough to rival other advertisement-supported media such as radio or TV. Additionally, it is known that files may be shared freely person-to-person, or may be downloaded from web site's servers or separate ftp servers, and companies, groups, or individuals can each provide them to the public; the problem with this is that there is no centralized way of controlling what content is offered, and there is little or no money being made on current business methods like that of Kazaa or Napster. Person-to-person applications require a one-time download of the software, and then through a search mechanism, all available files bearing the name or criteria of the individual's search may be located. The size, date, and name of the file are available as well as the name of the person offering the download, their connection speed, and the expected speed of the transfer. Typically these services, including Napster and Kazaa, propagate millions of dollars worth of online piracy of media files from TV shows, to films, to music; and are today believed to be stealing revenues from the music industry that would otherwise go to the media companies who produce the media content.

Recently, online companies like Pressplay.com have tried to offer legal alternatives to Kazaa and Napster that are endorsed by the larger media companies, such as subscription services for file streaming and/or downloading. But these services are slow to catch on with the public, and are growing slower than free file-sharing services like Kazaa. They are ultimately not as profitable as expected. Meanwhile the media industry continues its tremendous decline in revenue.

A need exists for a legal, free online media service that provides unlimited media content to the entire public for free as individual file streams, and depends upon advertising revenue.

A need also exists to reverse the current shrinking music industry by redirecting the enormous online piracy community into a legally legitimate file-streaming community.

A need further exists to offer a subscription service that is more desirable to millions of Internet surfers than the current generally unpopular online media subscription services available.

### BRIEF SUMMARY OF THE INVENTION

1. Solution to the Problem.

The present invention discloses an online file-streaming and advertising business method that provides a solution to the above problem by providing a means for allowing for the on-demand availability of all media content as individual file streams including films, TV programs, songs from all albums, both miscellaneous and rare video and sound clips, etc., for free to the public.

First, the advertising is paid for and appended to the media files. Second all of the files are located on the centralized network of servers, each to be individually accessible by the general public through local Internet Service Providers, and advertisers and independent investors pay for the associated traffic costs. Third, the user searches the network of servers to find the individual media file(s) they are looking for. Fourth, the user clicks to stream the individual file. The file is streamed: first the advertisement is shown, then the media is viewed. During the time after the advertisement is presented in the file stream, the user may fast forward and rewind for no longer than the initial duration of the song. Finally, the individual media file disappears from the computer and the user is left to find more.

This system provides a platform for advertisers to reach the Internet public in an effective way. This system provides a legal, reasonable alternative to both the current systems of online piracy, as well as the current systems of legal media file-streaming and downloading web sites and Internet companies that generally rely upon streaming bundles of files.

2. Summary.

The present invention discloses an online file-streaming and advertising method for integrating advertising into file streaming, that forces whomever streams the media file to also view or hear the advertisement. First the individual clicks to download. Then the stream starts to download but the individual cannot yet access the file—this is known as “buffering.” The advertisement is then played before the media can be viewed or heard. Then the media is viewed or heard and may be fast-forwarded or rewound so long as the stream is present for no longer than the set initial duration of the file stream. Finally, the file disappears off the individual's computer. The individual cannot skip past or get away from the advertisement. The individual cannot pirate or steal the media file in any way, because the file cannot be copied when it is streamed.

### BRIEF DESCRIPTION OF THE SEVERAL VIEWS OF THE DRAWINGS

FIG. 1. Web Site, one possible iteration

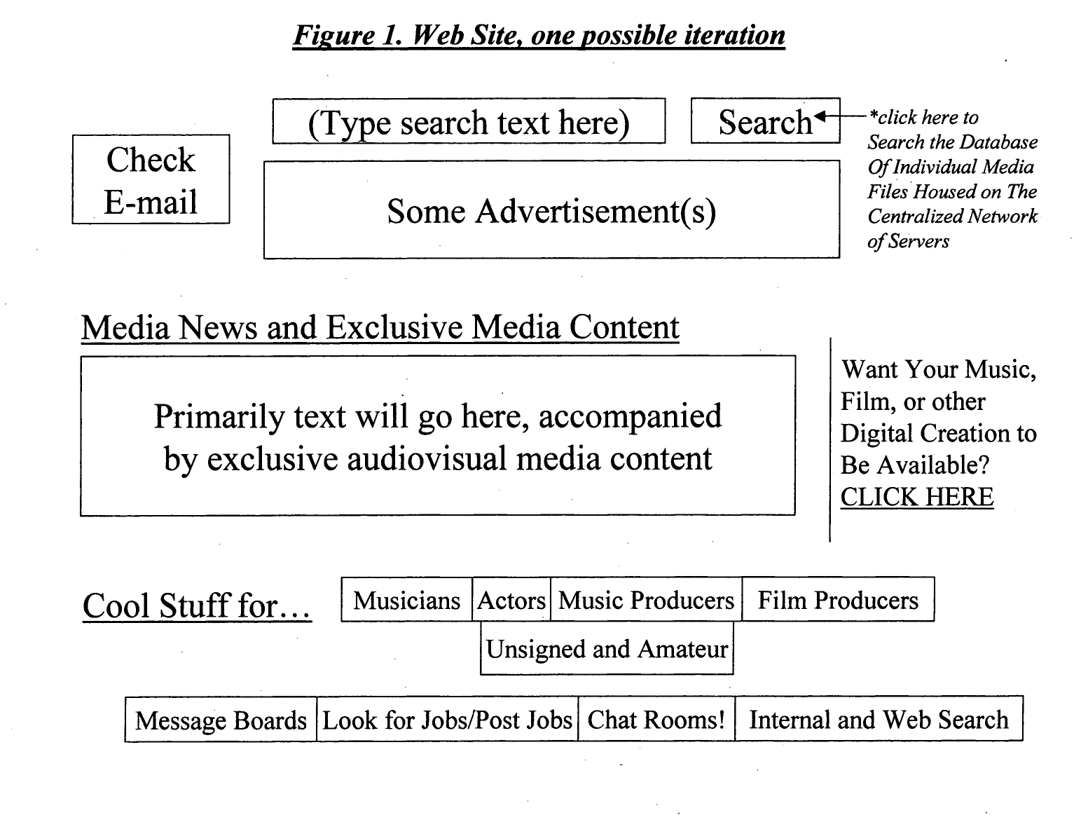

Diagram of how the virtual “web radio” web site would look if it were online. This diagram points to what the functions of the web site might be, and how it might be laid out. At the top, there is a search engine that can search the database of individual media files housed on the centralized network of servers.

FIG. 2. Flow of the Business Method

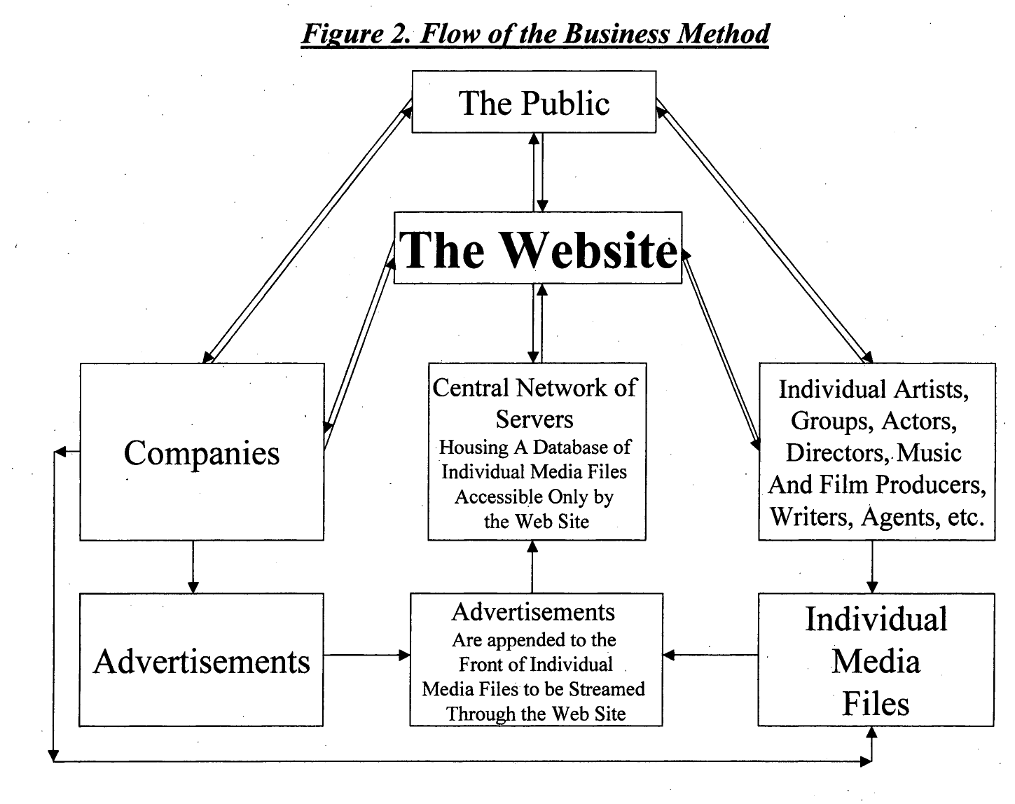

Details the process inherent in the business method. This diagram shows how the advertising content and media content gets to the individual, as well as the path that the individual media files take. It shows how the web site will be the central destination for the flow of the business method.

### DETAILED DESCRIPTION OF THE INVENTION

The best mode of carrying out this description can be attained when certain elements are in place. First, there must be a fully functional virtual “web radio” web site with the capability of accessing a centralized network of individual media files and streaming those files to individuals, that connects to homes and LANs through local Internet Service Providers. Second, advertisers must pay money to append their advertisements to the front of individual file streams. Third, the advertisements must be appended to the front of the streams of the individual media files so that the individual must first view or hear the advertisement before they hear or view the actual media content part of the file. Fourth, there must be a centralized network of servers, or at least a central database, physically in place that contains all the individual media files. Fifth, there must be a separate software program available to the public that endeavors to streamline individuals' usage of the web site for the purpose of the individuals' convenience. Finally, there should be a method in place that allows for optimized streaming. When the user starts streaming a file, the file will “buffer” enough so as to make the transfer fast and generally unproblematic. Part of this business method is already standard for streaming. When the viewer is finished viewing the stream, the file does not remain on the individual's computer.

The virtual “web radio” web site includes elements such as email, chat room, message boards for people involved or interested in working in the media industry at any level, headlines, and tailored search engines for Music, Film, TV, and Local. Additionally, it includes a section called “My Web Site,” which would function as the way for people who go to the site to customize the way it looks to them, to view their recent downloads, and to manage their profile. These features are inconsequential to the basic business method. They are a feature of a specific claim of the business method that is designed to make the virtual “web radio” web site into a portal with the purpose of assisting the creation of an online community based on and around the web site. In the basic business method however, the web site must only necessarily include a way to access the centralized network of servers containing the individual media files with advertisements appended to the front, and must then stream those files to the individual.

The invention has been described in detail with particular reference to preferred embodiments thereof, but it will be understood that variations and modifications can be effected within the spirit and scope of the invention. For example, other web site formats may be used, and there may be other acceptable methods for gathering all of the media content: a centralized network of servers is preferable for instance, but not necessary.

I claim:

1. A business method for taking media content of various formats that would otherwise normally be purchased online by individuals, such as movies or songs from albums, and making them available to the public for free, as individual files to be streamed on-demand via a virtual “web-radio”, the business method comprising:
A centralized network of servers housing a number of individual media files available for streaming, which connects to homes and LANs through local Internet Service Providers; wherein
the individual is prevented from copying or saving the streamed file; and
a web site, also located on the central network of servers, is the central destination for all individuals who wish to stream files from the virtual “web radio”; and
a software program utilizing the virtual “web radio” web site as its central component exists as an alternate gateway to the virtual “web radio” web site; and
the incidental natural formation of an online Internet community based on and around the free services is made possible by the method of appending advertisements to the front of file streams, and
making all of the media content that is desired by the public from the past to the present available for free on-demand, from student films to Sundance to Hollywood films, local bands to rappers to Nirvana, is the paramount reason for the incidental natural formation of this community.

2. The business method of claim 1, wherein advertisers pay to append their advertisement to the front of a given amount and type of streamed files; and
payment for the operation of the virtual “web radio” and all necessary costs associated with it depend significantly on the revenue earned from advertisers who pay to append their advertisements to the front of streams; and
the United States Federal Government and the Recording Industry Association of America both have a substantial interest in subsidizing the first year costs for the virtual “web radio” and all elements associated with it in the interest of combating Internet piracy.

3. The business method of claim 2, wherein the virtual “web radio” web site is also comprised of its own exclusive media-related exclusive content, provided by the same media companies whose content is available for streaming as individual files via the virtual “web radio”; and
exclusive printed content on the web site includes news, articles, and also both miscellaneous and rare audio and video, a world wide web search engine, chat rooms, message boards for both aspiring and experienced music groups, artists, producers of radio, music, television, and film, technicians, film and TV writers, and songwriters, an internal site search engine for printable content, a free email service.

4. The business method of claim 2, wherein promotion of the virtual “web radio” web site and software program both regionally and nationally is generally paid for by advertisers and individual investors as a necessary cost of doing business; and
the virtual “web radio” is promoted to consumers as a reasonable replacement for popular file-downloading programs such as Kazaa and Napster.

5. The business method of claim 2, wherein overhead costs for the virtual “web radio” are paid in part by commission on moneys from advertisers.

6. The business method of claim 3, wherein exclusive printed and audiovisual media content will be provided by the same media companies whose regular content is offered for streaming as individual files on the virtual “web radio” for the additional purpose of drawing consumers to the web site; and
the exclusive media content will also be the motivation for consumers to stay for extended periods of time, viewing content and thus simultaneously advertisements.

7. The business method of claim 3, wherein the presence of a search engine, email service, chat rooms, and message board components of the web site associated with the virtual “web radio” contribute to the formation of an Internet community based on and around the web site.

8. The business method of claim 7, wherein the message boards for both aspiring and experienced film, TV, and music producers, artists, film and TV writers, bands, performers, and technicians help make the community accessible to foreign Internet users, thus expanding global recognition of the virtual “web radio;” and
the presence of an Internet community based on and around the virtual “web radio” web site further embeds the virtual “web radio” into the lifestyle of those who use it for the purpose of increasing the potential for generating revenue from each consumer's visit to the web site.
